(19) United States
(12) Patent Application Publication
(10) Pub. No.: US 2026/0288388 A1
(43) Pub. Date: Sep. 24, 2026

(54) NON-TRANSITORY COMPUTER READABLE STORAGE MEDIUM AND INFORMATION PROCESSING DEVICE

(71) Applicant: BROTHER KOGYO KABUSHIKI KAISHA, Nagoya (JP)

(72) Inventor: Ryota Kakitsuba, Nagoya (JP)

(21) Appl. No.: 19/570,653

(22) Filed: Mar. 18, 2026

Related U.S. Application Data
(63) Continuation of application No. PCT/JP2025/004105, filed on Feb. 7, 2025.

(30) Foreign Application Priority Data
Mar. 21, 2024 (JP) 2024-045218

(51) Int. Cl. G06F 3/12

(52) U.S. Cl. CPC G06F 3/1228; G06F 3/1204; G06F 3/1232

(57) ABSTRACT

A non-transitory computer readable storage medium storing an information processing program executable by a processor of an information processing device. The information processing program is configured to execute print control using the printing device by communicating with the printing device to be connected to the information processing device. The information processing device is loaded with an operating system having OS standard printing software. The information processing program is configured to cause, when the printing device is not yet connected to the information processing device, a controller of the information processing device to execute a registration process and a capability information output process with the OS standard printing software.

### REFERENCE TO RELATED APPLICATIONS

This is a continuation application of International Application No. PCT/JP 2025/004105 filed on Feb. 7, 2025, which claims priority from Japanese Patent Application No. 2024-045218 filed on Mar. 21, 2024. The entire contents of the aforementioned applications are incorporated herein by reference.

### BACKGROUND ART

Related art describes an operating system (OS) having a so-called driverless printing function for executing printing according to a predetermined printing standard without using a printer driver provided by a printer vendor. In this case, printing can be executed without installing a printer driver.

As a technique, using such a driverless OS standard printing software function, for supporting a printer that does not support driverless printing or for extending the function of normal driverless printing, for example, a technique is known in which a virtual printing device that receives a print job from OS standard printing software and transmits the received print job to a printer is created in an information processing device.

In the related art, as the virtual printing device is registered in the OS standard printing software, print data from the OS standard printing software is outputted to the virtual printing device, and printing based on the print data is executed. In a case where the virtual printing device is registered, capability information is acquired from an actual printing device that is not virtual (hereinafter, appropriately referred to as “actual printing device”), and registration is performed based on the capability information. Therefore, it is not possible to perform initial setting or the like on the information processing device until the actual printing device is connected, which is inconvenient.

An object of the present disclosure is to provide an information processing program and an information processing device capable of registering a virtual printing device in advance to enable initial setting and the like to be executed even in a state where an actual printing device is not connected, and executing a printing operation when the actual printing device is connected later.

### SUMMARY

A non-transitory computer readable storage medium storing an information processing program executable by a processor of an information processing device, the information processing program being configured to execute print control using the printing device by communicating with the printing device connected to the information processing device, the information processing device being loaded with an operating system having OS standard printing software,
in which the information processing program is configured to, when executed by the processor, cause, on the condition that the printing device is not yet connected to the information processing device, a controller of the information processing device to execute:
   a registration process of registering, as a virtual printer corresponding to the printing device, the information processing program in the OS standard printing software by responding to a search for a printer according to the OS standard printing software; and
   a capability information output process of outputting capability information of the printing device in response to a request for the capability information from the OS standard printing software, and
the information processing program is configured to, when executed by the processor, cause, after the printing device is connected to the information processing device, the controller of the information processing device to execute:
   a print data acquisition process of acquiring first print data from the OS standard printing software corresponding to the capability information outputted in the capability information output process; and
   a print data transmission process of transmitting second print data based on the first print data to the connected printing device.

### BRIEF DESCRIPTION OF DRAWINGS

FIG. 1 is a block diagram illustrating an example of a system configuration of a printing system and a functional configuration of a terminal device according to an embodiment of the present disclosure.

FIG. 2 is a diagram illustrating an example of setting value information of a printer.

FIG. 3A is a flowchart illustrating an example of a control procedure in which a printer application is registered in a CUPS in a state where a printer is not connected to a terminal device after the printer application is installed.

FIG. 3B is a flowchart illustrating an example of the control procedure in which the printer application is registered in the CUPS in a state where the printer is not connected to the terminal device after the printer application is installed.

FIG. 4 is a flowchart illustrating an example of a control procedure when a user issues a print execution instruction after the CUPS registers a printer application as a virtual printer.

FIG. 5 is a block diagram illustrating an example of a system configuration of a printing system and a functional configuration of a terminal device in a modification in which capability information and setting value information are acquired after installation.

FIG. 6A is a flowchart illustrating an example of a control procedure in a modification in which capability information and setting value information are acquired after installation.

FIG. 6B is a flowchart illustrating an example of the control procedure in the modification in which capability information and setting value information are acquired after installation.

FIG. 7 is a block diagram illustrating an example of a hardware configuration of the terminal device and the printer.

### DESCRIPTION

### Embodiment

An embodiment of the present disclosure will be described with reference to the drawings.

### Outline of Printing System

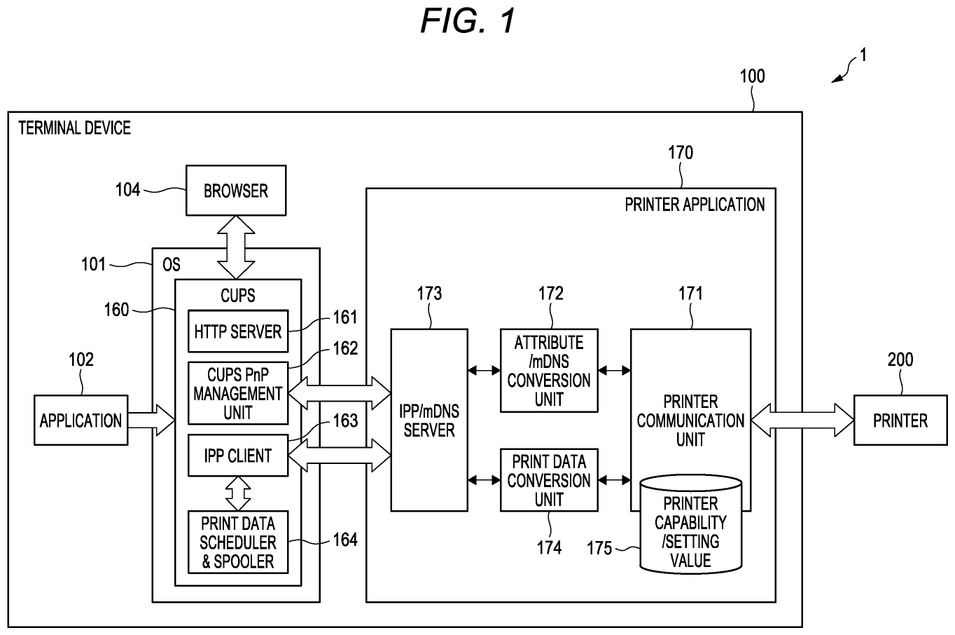

FIG. 1 illustrates an example of a system configuration of a printing system 1 according to the present embodiment. In FIG. 1, a printing system 1 includes a terminal device 100 and a printer 200. The terminal device 100 and the printer 200 are communicably connected via, for example, the Internet, a wired LAN, a wireless LAN, or the like. The terminal device 100 is an example of an information processing device, and the printer 200 is an example of a printing device and an actual printing device.

### Functional Configuration of Terminal Device

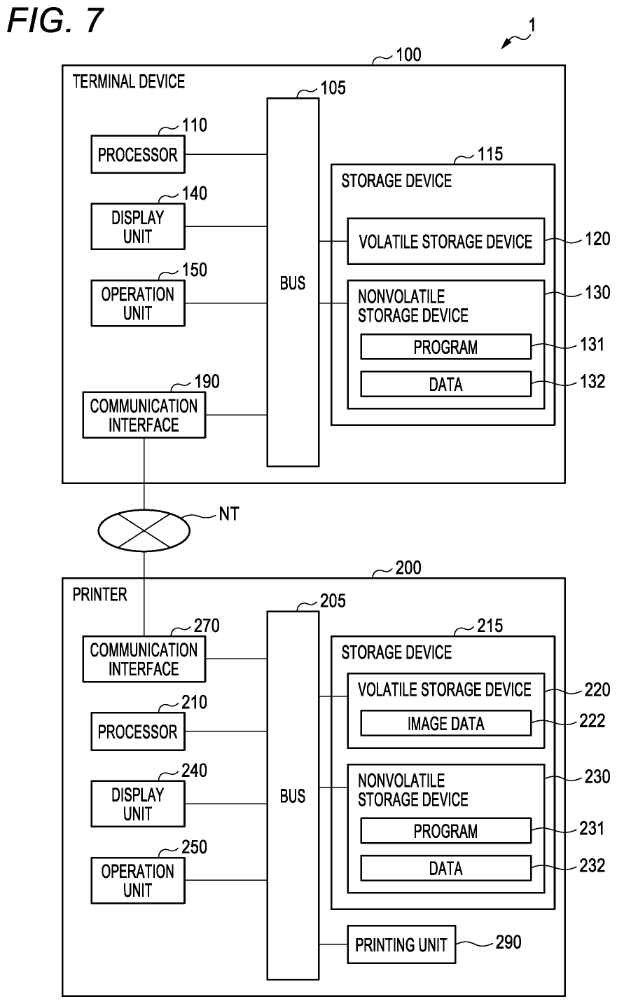

The terminal device 100 is configured to transmit print data to the printer 200 to execute printing. The terminal device 100 is, for example, a desktop PC, a notebook PC, or a tablet computer. Alternatively, the terminal device 100 may be a mobile terminal such as a smartphone. Although details will be described later, the terminal device 100 includes a processor 110 and a storage device 115 configured to store various printing processing programs (see FIG. 7 to be described later). As the processor 110 executes various printing processing programs, the terminal device 100 has the functional configuration illustrated in FIG. 1.

As illustrated in FIG. 1, the terminal device 100 includes an operating system (OS) 101, an editing application 102, a printer application 170, and a browser 104. The OS 101 has a so-called driverless printing function of executing printing according to a predetermined printing standard without using a printer driver provided by a printer vendor.

The OS 101 includes, for example, a common unix printing system (CUPS) 160, which is a modularized printing system for the OS. The OS 101 is an example of an operating system, and the CUPS 160 is an example of OS standard printing software.

### CUPS

The CUPS 160 includes an HTTP server 161, a CUPS PnP management unit 162, an IPP client 163, and a print data scheduler & spooler 164.

The HTTP server 161 is server software configured to operate on the CUPS 160. The HTTP server 161 is configured to acquire information and functions using a hypertext transfer protocol (HTTP) via the browser 104, or provide information and functions thereto.

The CUPS PnP management unit 162 has a plug and play (PnP) function of registering, in the CUPS 160, a printer (including a virtual printing device) detected using a protocol such as multicast Domain Name System/Service Discovery (mDNS/SD) to create a print queue.

The CUPS PnP management unit 162 is configured to change the setting so that a search address for PnP is limited to an internal network (normally, IP address 127.0.0.1) of the terminal device 100 using a script executed when the printer application 170 is installed. Therefore, the CUPS 160 cannot directly recognize the printer 200, and is configured to recognize the printer application 170 as a printer. The printer application 170 is not a real printer but a so-called virtual printer configured to act as a printer for the CUPS 160. The printer application 170 realizes printing using the CUPS 160 and the printer 200 by mediating between the CUPS 160 and the printer 200. The printer application 170 is an example of a virtual printing device.

The IPP client 163 is configured to transmit and receive print data or an attribute to and from an IPP/mDNS server 173 to be described below using the IPP protocol.

The print data scheduler & spooler 164 is configured to manage a print job transmitted from the editing application 102 or the like, and the print data scheduler & spooler 164 is configured to temporarily block a plurality of print jobs generated at the same time and manage the print jobs to be transferred to the IPP client 163.

### Printer Application

The printer application 170 is configured to be registered in the CUPS 160 as a virtual printer corresponding to the connected printer 200. The CUPS 160 is configured to handle the printer application 170 as a virtual printer and executes various processes related to printing. The various processes include, for example, a printer search process and a capability information request process. The printer application 170 includes a printer communication unit 171, an attribute/mDNS conversion unit 172, the IPP/mDNS server 173, a print data conversion unit 174, and a printer capability and setting value storage unit 175. The printer application 170 is an example of an information processing program.

The printer communication unit 171 is configured to communicate with the printer 200 using the IPP protocol. The printer communication unit 171 is configured to receive an attribute from the printer 200 and transmit print data to the printer 200.

In a case where the printer 200 is connected to the terminal device 100, the attribute/mDNS conversion unit 172 is configured to acquire an attribute representing the capability of the printer 200 via the printer communication unit 171. In a case where the printer 200 is not yet connected to the terminal device 100, the attribute/mDNS conversion unit 172 reads an attribute, which is capability information and setting value information of the printer 200 scheduled to be connected, from the printer capability and setting value storage unit 175. The attribute/mDNS conversion unit 172 is configured to convert the attribute acquired from the printer 200 or the printer capability and setting value storage unit 175 into an attribute corresponding to a printing function that can be handled by the CUPS 160.

The attribute/mDNS conversion unit 172 has a function of a multicast domain name system (mDNS). The mDNS is configured to simultaneously distribute a DNS inquiry in a local network by Internet Protocol (IP) multicast, and simultaneously make an inquiry to all devices in the same network. A device that has received the inquiry is configured to transmit its own IP address as a response.

In response to the capability information request process of the CUPS 160, the IPP/mDNS server 173 is configured to output the attribute converted by the attribute/mDNS conversion unit 172 to the CUPS 160. The CUPS 160 is configured to output print data corresponding to the attribute converted by the IPP client 163. The IPP/mDNS server 173 is configured to acquire print data corresponding to the converted attribute output from the CUPS 160, and output the print data to the print data conversion unit 174. The IPP/mDNS server 173 has a function of mDNS similarly to the attribute/mDNS conversion unit 172.

The print data conversion unit 174 is configured to acquire print data from the CUPS 160 via the IPP/mDNS server 173. The print data conversion unit 174 is configured to convert the print data acquired from the CUPS 160 into print data corresponding to a printing function of the printer 200. The print data conversion unit 174 is configured to output the converted print data to the printer communication unit 171.

The printer communication unit 171 is configured to transmit the print data output from the print data conversion unit 174 to the printer 200.

In the printer capability and setting value storage unit 175, capability information and setting value information of the printer 200 scheduled to be connected to the terminal device 100 are stored, in advance, in a state where the printer 200 is not yet connected to the terminal device 100. The printer application 170 may hold the capability information and the setting value information at the time of installation in the terminal device 100. For example, the capability information and the setting value information may be customized in an installer for installing the printer application 170 in the terminal device 100. The capability information is information indicating the printing capability of the printer 200 scheduled to be connected, and includes, for example, a printing color such as color or monochrome, a size of a printing sheet, and a type of a printing sheet.

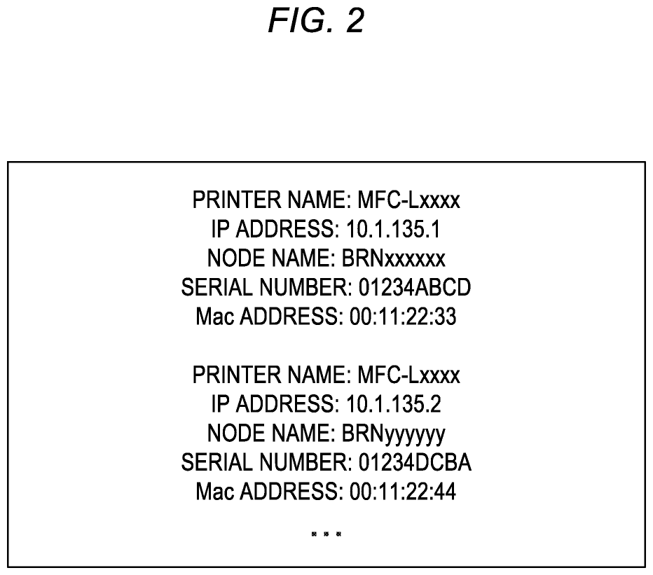

FIG. 2 illustrates an example of the setting value information of the printer 200. In the example illustrated in FIG. 2, the setting value information includes printer names, IP addresses, node names, serial numbers, MAC addresses, and the like of the two printers 200 scheduled to be connected. The printer name may be a model name of a printer or a name named by the user. The IP address or the node name is an example of access information of a printing device, and the serial number or the MAC address is an example of identification information. In the example illustrated in FIG. 2, the setting value information related to a plurality of printers 200 is included, or the setting value information related to one printer 200 may be included. Similarly, the capability information of the printer 200 scheduled to be connected may be capability information related to one or more printers 200. That is, the capability information and the setting value information of the printer 200 held by the printer application 170 may correspond to one printer 200 or the plurality of printers 200.

### Control Procedure

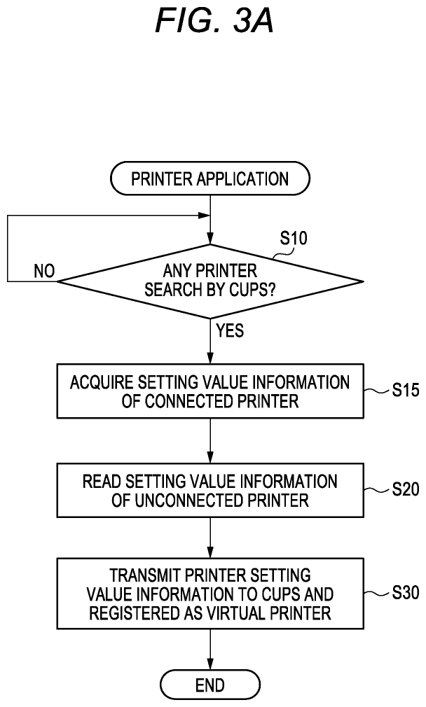

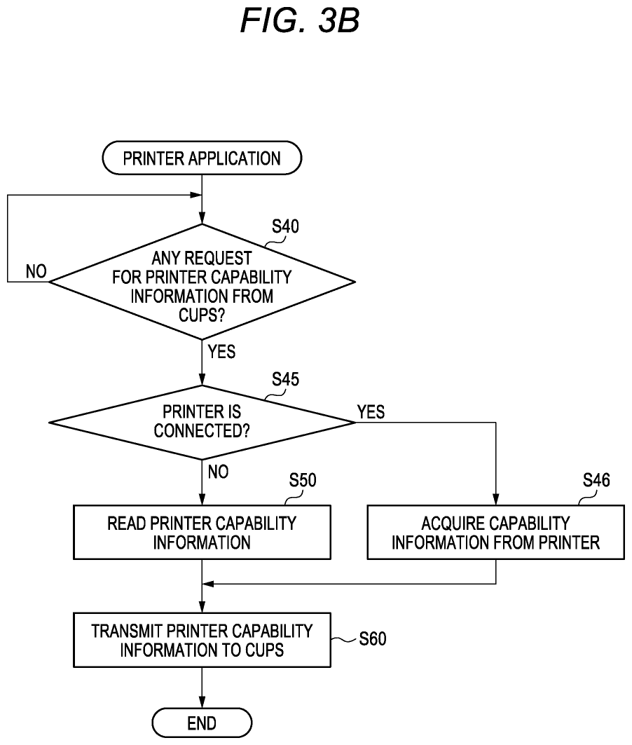

In the present embodiment, the printer application 170 is installed in the terminal device 100 regardless of whether the printer 200 is connected to the terminal device 100 or not. A situation in which the printer 200 is not yet connected to the terminal device 100 may occur, for example, in a case where the terminal device 100 is delivered to the user first and the printer 200 is delivered later, and in a case where an initial setting or the setup is executed for the terminal device 100 first. A control procedure for registering the printer application 170 in the CUPS 160 in a state where the printer 200 is not connected to the terminal device 100 after the printer application 170 is installed will be described with reference to the flowchart of FIGS. 3A and 3B.

As illustrated in FIG. 3A, first, in step S10, the printer application 170 determines whether a printer search process has been executed by the CUPS 160. The printer search process is a process for searching for the printer 200 (including a virtual printer) to be subjected to print processing, and is executed by the CUPS PnP management unit 162 of CUPS 160 using a protocol of mDNS/SD or the like. The printer application 170 repeats this step S10 until the CUPS 160 executes the printer search process (step S10: No), and advances the process to the next step S15 when the printer search process is executed (step S10: Yes).

In step S15, the printer application 170 detects the printer 200 connected to the terminal device 100, and acquires setting value information and capability information from the detected printer 200 (S15). As an example of a detection method, the printer application 170 distributes an inquiry by the mDNS from the attribute/mDNS conversion unit 172, and detects that the printer is connected if there is a response. In step S20, the printer application 170 reads, from the printer capability and setting value storage unit 175, the setting value information of the printer 200 scheduled to be connected (S20). When it is detected in step S15 that the printer 200 scheduled to be connected is connected, it is assumed that the printer 200 is connected later, and the process of step S20 is skipped.

In step S30, the printer application 170 transmits the setting value information read in step S15 or S20 to the CUPS 160 by responding to a search for a printer by the CUPS 160. Accordingly, the CUPS 160 registers the printer application 170 that has responded with the new setting value information as a virtual printer corresponding to the printer 200. In a case where the printer application 170 responds with the setting value information of the plurality of printers 200, the CUPS 160 registers the printer application 170 as a plurality of virtual printers corresponding to the plurality of printers 200. Step S30 is an example of a registration process. After step S30, the printer application 170 ends this flowchart.

Next, the CUPS 160 requests capability information to the printer application 170 registered as a virtual printer, and thus a flowchart for the printer application 170 to respond to a request will be described. As illustrated in FIG. 3B, in step S40, the printer application 170 determines whether the capability information request process is executed by the CUPS 160. The capability information request process is a process of requesting the printing capability of the registered printer 200 (including a virtual printer). In a case where the plurality of printers 200 (including virtual printers) are registered, the CUPS requests the printing capability for each printer. The printer application 170 repeats this step S40 until the capability information request process is executed by the CUPS 160 (step S40: No), and advances the process to the next step S45 when the capability information request process is executed (step S40: Yes).

In step S45, the printer application 170 determines whether the printer 200 has been connected to the terminal device 100. When it is determined that the printer 200 has been connected to the terminal device 100 (S45: Yes), the printer application 170 acquires capability information from the printer 200 (S46). On the other hand, when it is determined that the printer 200 is not yet connected to the terminal device 100 (S45: No), the printer application 170 reads, from the printer capability and setting value storage unit 175, the capability information of the printer 200 scheduled to be connected (S50).

In step S60, in response to the request for capability information from the CUPS 160, the printer application 170 transmits the capability information read in step S46 or acquired in step S50 to the CUPS 160. Step S60 is an example of a capability information output process. Thus, the printer application 170 ends this flowchart.

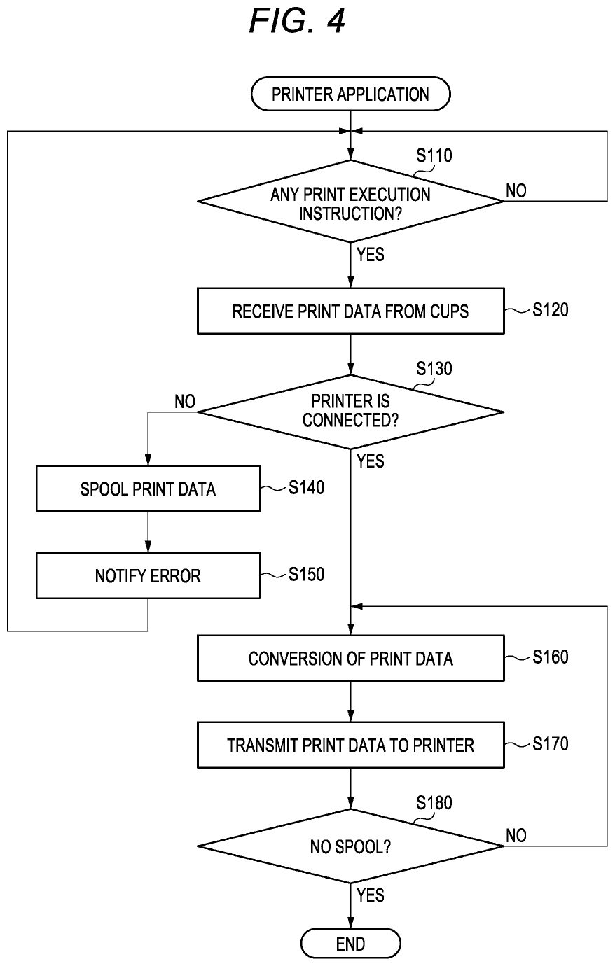

A control procedure when the user issues a print execution instruction after the CUPS 160 registers the printer application 170 as a virtual printer will be described with reference to the flowchart of FIG. 4.

As illustrated in FIG. 4, first, in step S110, the printer application 170 determines whether a print execution instruction has been issued by the user. The print execution instruction is a print execution instruction based on the print data from the CUPS 160 corresponding to the capability information outputted in step S60 described above. In the present embodiment, the user can issue a print execution instruction regardless of whether the printer 200 is connected to the terminal device 100. The printer application 170 repeats this step S110 until a print execution instruction is issued (step S110: No), and advances the process to the next step S120 when a print execution instruction is issued (step S110: Yes). The Yes determination in step S110 in a state where the printer 200 is not connected to the terminal device 100 is an example of an instruction receiving process.

In step S120, the printer application 170 receives the print data from the CUPS 160. The print data is print data from the CUPS 160 corresponding to the capability information outputted to the CUPS 160 in step S60 described above. The print data when step S120 is executed in a state where the printer 200 is connected to the terminal device 100 is an example of the first print data, and step S120 in this case is an example of the print data acquisition process. The print data when step S120 is executed in a state where the printer 200 is not connected to the terminal device 100 is an example of third print data.

In step S130, the printer application 170 determines whether the printer 200 is connected to the terminal device 100. For example, the printer application 170 distributes an inquiry by the mDNS from the attribute/mDNS conversion unit 172, and performs the determination according to the presence or absence of a response. When it is determined that the printer 200 is not connected to the terminal device 100 (step S130: No), the printer application 170 advances the process to the next step S140.

In step S140, the printer application 170 temporarily spools, in an appropriate storage region, the print data received in step S120.

In step S150, the printer application 170 outputs, to a display unit 140 (see FIG. 7 to be described later), a display signal for performing an error display corresponding to printing disabled. The error display may be, for example, a display indicating that printing is disabled, such as toner empty or sheet exhaustion. In addition to the display, for example, an error notification may be performed by voice. The error display is an example of a first error notification, the display signal is an example of a first notification signal, and step S150 is an example of a first notification signal output process. After step S150, the printer application 170 advances the process to step S110.

On the other hand, in step S130, when the printer application 170 determines that the printer 200 is connected to the terminal device 100 (step S130: Yes), the printer application 170 advances the process to the next step S160.

In step S160, the printer application 170 causes the print data conversion unit 174 to convert the print data received in step S120 into print data corresponding to the printing function of the printer 200. The print data converted in step S160 when step S120 is executed in the state where the printer 200 is connected to the terminal device 100 is an example of second print data based on the first print data. The print data converted in step S160 when step S120 is executed in the state where the printer 200 is not connected to the terminal device 100 is an example of fourth print data based on the third print data.

In step S170, the printer application 170 transmits the print data converted in step S160 to the printer 200 connected to the terminal device 100. Step S170 is an example of a print data transmission process.

In step S180, the printer application 170 determines whether the spooled print data remains. When the spooled print data remains (step S180: No), the printer application 170 returns to step S160 and repeats step S160 and step S170 until no spooled print data remains. When no spooled print data remains (step S180: Yes), the printer application 170 ends this flowchart.

As described above, the print data spooled before the printer 200 is not connected can be printed after the printer 200 is connected. In the above-described control procedure, the spooled print data is not printed unless the print execution instruction is issued, but the spooled print data may be automatically printed even if the print execution instruction is not issued when the connection of the printer 200 is detected.

### Effects of Embodiment

In the present embodiment, when the printer 200 is not yet connected to the terminal device 100, the printer application 170 causes the processor 110 of the terminal device 100 to execute step S30 and step S60. In step S30, the printer application 170 responds to the search for the printer 200 by the CUPS 160, so that the printer application 170 is registered as a virtual printer corresponding to the printer 200 scheduled to be connected to the CUPS 160. In step S60, in response to the request for the capability information from the CUPS 160, the printer application 170 outputs the capability information of the printer 200 scheduled to be connected. As described above, according to the present embodiment, even in the state where the printer 200 is not actually connected, it is possible to register the virtual printer in advance and output the capability information of the printer 200 scheduled to be connected, and thus it is possible to execute various initial settings, setup, and the like in the terminal device 100. Accordingly, the convenience can be improved.

After the printer 200 is connected to the terminal device 100, the printer application 170 causes the processor 110 of the terminal device 100 to execute step S120 and step S170. In step S120, the print data from the CUPS 160 corresponding to the capability information output in step S60 is acquired. In step S170, the print data is transmitted to the printer 200 connected to the terminal device 100, and printing is executed. As described above, according to the present embodiment, when the printer 200 that has not been connected is connected later, a printing operation can be executed.

As described above, for example, in the case where the terminal device 100 is delivered to the user first and the printer 200 is delivered later, the initial setting and the setup can be executed for the terminal device 100 first. At this time, since the initial setting and the setup can be collectively executed for the plurality of terminal devices 100 and the initial setting and the setup of the plurality of printers 200 can be executed for each terminal device 100, the convenience can be significantly improved.

In the present embodiment, in particular, when the printer 200 is not yet connected to the terminal device 100, the printer application 170 executes step 110 of receiving a print execution instruction. In step S170, the printer application 170 transmits print data based on the spooled print data to the printer 200 connected to the terminal device 100. Accordingly, even when a print execution instruction is received in the state where the printer 200 is not connected, print data can be transmitted to the printing device and printing can be executed when the printer 200 is connected thereafter.

In the present embodiment, in particular, when the printer application 170 receives a print execution instruction while the printer 200 is not yet connected to the terminal device 100, the printer application 170 executes step 150 of outputting a display signal for performing corresponding error display. Accordingly, when the print execution instruction is received in the state where the printer 200 is not connected, the error display is performed, so that the user can recognize that the printer 200 is not connected.

In the present embodiment, in particular, the printer capability and setting value storage unit 175 stores setting value information including access information and identification information of the printer 200 scheduled to be connected in addition to the capability information of the printer 200 scheduled to be connected. Accordingly, even when the printer 200 is not yet connected to the terminal device 100, the CUPS 160 can register the printer application 170 as a virtual printer using the access information and the identification information.

### Modification

The present invention is not limited to the above-described embodiment, and various modifications are possible without departing from the gist and technical idea of the above-described embodiment.

### (1) When Capability Information and Setting Value Information Are Input After Installation

In the above embodiment, a case where the printer application 170 holds in advance the capability information and the setting value information of the printer 200 scheduled to be connected before the printer application 170 is installed in the terminal device 100 has been described, but for example, the information may be input after the installation.

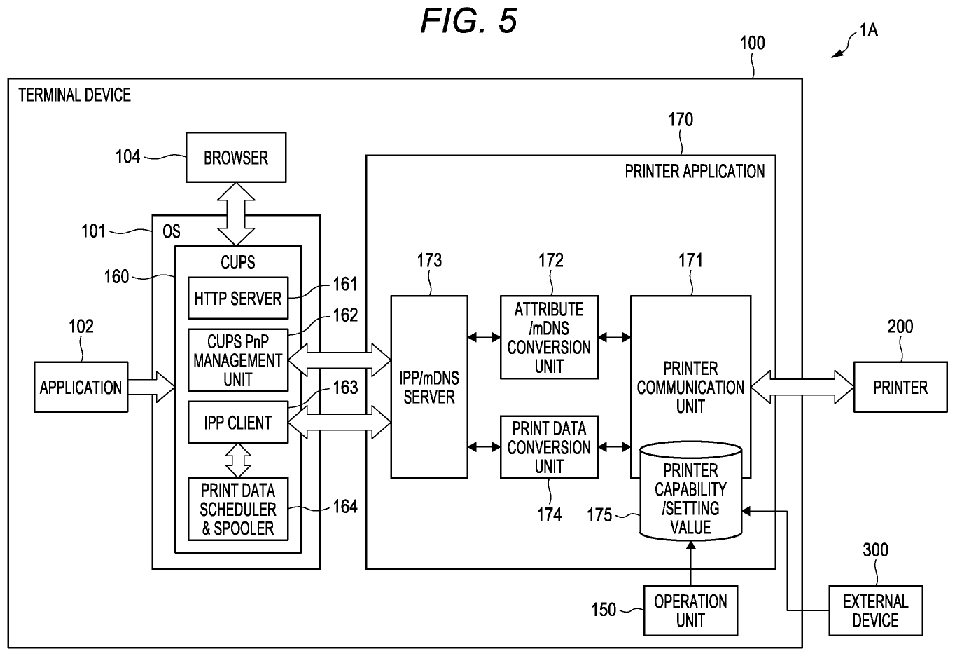

FIG. 5 illustrates an example of a system configuration of a printing system 1A according to the present modification. As illustrated in FIG. 5, the printing system 1A includes the above-described terminal device 100, the printer 200, and an external device 300. In the present modification, when the printer application 170 is installed, the capability information and the setting value information of the printer 200 scheduled to be connected are not stored in the printer capability and setting value storage unit 175. The terminal device 100 includes an operation unit 150. The operation unit 150 is, for example, a mouse or a keyboard, and receives input of capability information and setting value information of the printer 200 by the user. After installing the printer application 170, the user inputs the capability information and the setting value information of the printer 200 via the operation unit 150, and stores the capability information and the setting value information in the printer capability and setting value storage unit 175.

The capability information and the setting value information of the printer 200 may be acquired from the external device 300 instead of the input by the operation unit 150. The external device 300 is a removable recording medium such as a USB memory, an optical disk, or an external hard disk. The external device 300 is configured to store the capability information and the setting value information of the printer 200 scheduled to be connected, and when the printer 200 is connected to the terminal device 100, the capability information and the setting value information are acquired and stored in the printer capability and setting value storage unit 175. The external device 300 may be a terminal device such as a computer or a smartphone. In this case, the capability information and the setting value information may be set and edited in the external device 300. The printing system 1A may include both the operation unit 150 and the external device 300, or may include only one of the operation unit 150 and the external device 300.

### Control Procedure

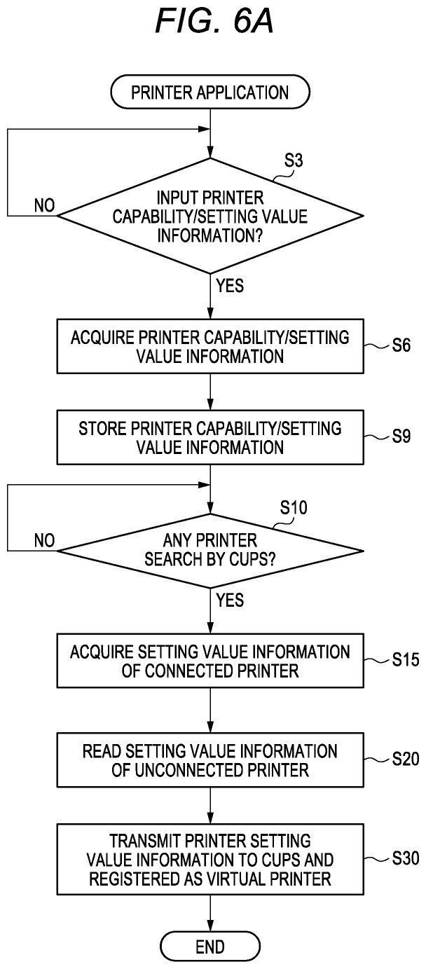

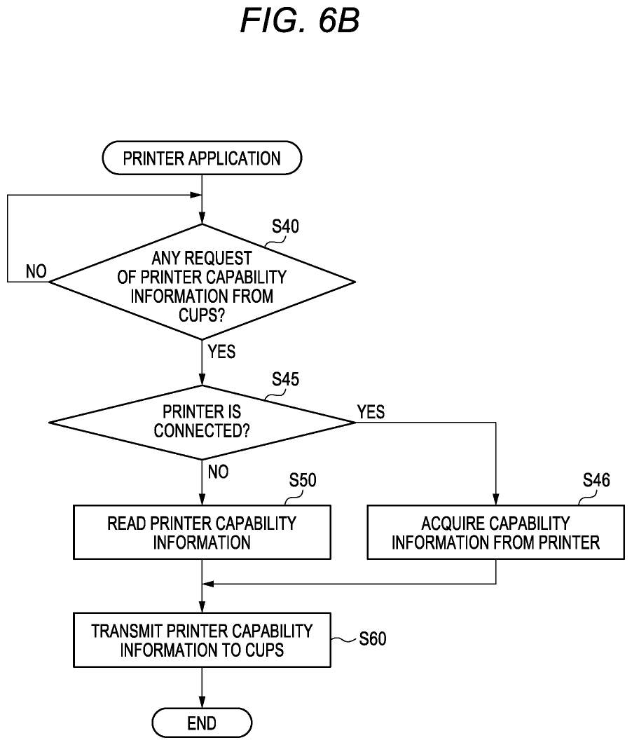

In the present modification, as in the above-described embodiment, the printer application 170 is installed in the terminal device 100 in the state where the printer 200 is not yet connected to the terminal device 100. In the present modification, before the printer application 170 is registered in the CUPS 160, the capability information and the setting value information of the printer 200 scheduled to be connected are acquired. A control procedure in the present modification will be described with reference to a flowchart of FIGS. 6A and 6B. In FIGS. 6A and 6B, the same steps as those in FIGS. 3A and 3B are denoted by the same reference numerals, and the description thereof will be appropriately omitted.

As illustrated in FIG. 6A, first, in step S3, the printer application 170 determines whether the capability information and the setting value information of the printer 200 are input. The input of the capability information and the setting value information is, for example, input by the user via the operation unit 150, connection of the external device 300, or transmission from the external device 300. The printer application 170 repeats step S3 until the capability information and the setting value information are input (step S3: No), and advances the process to the next step S6 when the capability information and the setting value information are input (step S3: Yes).

In step S6, the printer application 170 acquires the capability information and the setting value information of the printer 200 scheduled to be connected. The acquired setting value information includes an IP address, a node name, a serial number, a MAC address, and the like of the printer 200 scheduled to be connected, as in the above-described embodiment. The printer application 170 may receive and acquire the input of the capability information and the setting value information via the operation unit 150 provided in the terminal device 100, for example. The printer application 170 may receive and acquire the capability information and the setting value information transmitted from the external device 300, for example. Step S6 is executed before step S30 of registering the printer application 170 in the CUPS 160 as a virtual printer. Step S6 is an example of a capability information acquisition process.

In step S9, the printer application 170 stores and holds the capability information and the setting value information acquired in step S6 in the printer capability and setting value storage unit 175. Step S9 is an example of a capability information storage process.

Since subsequent steps S10 to S60 are the same as those in FIGS. 3A and 3B described above, description thereof will be omitted.

### Effects of Modification

In the present modification, when the printer application 170 is installed in the terminal device 100, the capability information and the setting value information of the printer 200 scheduled to be connected are not held in the printer application 170. By executing step S6 before step S30, the printer application 170 can acquire and store the capability information and the setting value information of the printer 200. The printer application 170 can appropriately read out the stored setting value information and capability information in response to a request from the CUPS 160 and output the value information and capability information to the CUPS 160. According to the present modification, the capability information and the setting value information can be stored after installation of the printer application 170.

### (2) When Notifying Unconnected State of Printer

For example, when the printer 200 is not yet connected to the terminal device 100, an unconnected state of the printer 200 may be notified. For example, the printer application 170 may output, to the display unit 140 (see FIG. 7 to be described later), a display signal for performing an error display corresponding to the unconnected state of the printer 200. The error display may be a display indicating that the printer 200 is unusable, such as power-off of the printer 200. In addition to the display, for example, an error notification may be performed by voice. The error display is an example of a second error notification, the display signal is an example of a second notification signal, and a process of performing the error display is an example of a second notification signal output process.

In the present modification, an error display is performed in the state where the printer 200 is not connected, so that the user can recognize that the printer 200 is not connected and printing cannot be immediately executed.

### (3) Others

The flowcharts illustrated in FIGS. 3A, 3B, 4, 6A, and 6B do not limit the present disclosure to the procedures illustrated in the above flow, and addition, deletion, change in the order, and the like of the procedures may be made without departing from the gist and the technical idea of the invention.

In addition to the above, the methods according to the embodiment and the modifications may be appropriately combined and used.

In addition, although not shown, the present invention may be carried out with various modifications within a scope not departing from the gist thereof.

### Hardware Configuration of Terminal Device and Printer

An example of a hardware configuration of the terminal device 100 and the printer 200 will be described with reference to FIG. 7.

### Terminal Device

As illustrated in FIG. 7, the terminal device 100 includes the processor 110, the storage device 115, the display unit 140, an operation unit 150, and a communication interface 190. The processor 110, the storage device 115, the display unit 140, the operation unit 150, and the communication interface 190 are connected to each other via a bus 105 to be able to transmit and receive data.

The storage device 115 includes a volatile storage device 120 and the nonvolatile storage device 130. The volatile storage device 120 is, for example, a DRAM, and configured to store various programs and data to be processed. The nonvolatile storage device 130 is, for example, a hard disk drive or a solid state drive, and includes a program storage region 131 and the data storage region 132.

Various programs are stored in the program storage region 131. The various programs include the printer application 170, the printing processing programs, and the like described above based on the flowcharts of FIGS. 3A, 3B, 4, 6A, and 6B described above. The data storage region 132 stores data and the like necessary for executing various programs.

The processor 110 is a device configured to execute data processing, for example, a CPU, and executes various programs stored in the program storage region 131. The processor 110 is configured to execute various processes including data communication with the printer 200 connected to a network NT. The processor 110 and the programs stored in the program storage region 131 are examples of a calculation unit and a controller.

The display unit 140 is, for example, a liquid crystal display, and may be configured to display various types of information. The operation unit 150 is, for example, a keyboard or a button, and configured to receive an input operation by the user. The user may operate the operation unit 150 to input various instructions to the terminal device 100.

The communication interface 190 is an interface for communicating with other devices, and is connected to the network NT. The communication interface 190 is an example of a communication I/F.

The storage device 115 is not limited to the configuration of the above-described device elements, and may be implemented by, for example, a RAM, a ROM, an EEPROM, an HDD, a portable recording medium such as a USB memory attached to and detached from the terminal device 100, a buffer included in the processor 110, or a combination thereof.

The storage device 115 may be a computer-readable storage medium. The computer-readable storage medium is a non-transitory medium. The non-transitory medium also includes a recording medium such as a CD-ROM or a DVD-ROM, in addition to the above-described examples. The non-transitory medium is also a tangible medium. The same applies to a storage device 215 of the printer 200 to be described later.

### Printer

As illustrated in FIG. 7, the printer 200 includes a processor 210, a storage device 215, a display unit 240, an operation unit 250, a communication interface 270, and a printing unit 290. The processor 210, the storage device 215, the display unit 240, the operation unit 250, the communication interface 270, and the printing unit 290 are connected to each other via a bus 205 to be able to transmit and receive data.

The storage device 215 includes a volatile storage device 220 and a nonvolatile storage device 230. The volatile storage device 220 is, for example, a DRAM, and includes an image data storage region 222 that stores image data to be printed. The nonvolatile storage device 230 is, for example, an NVRAM, and a flash memory, and includes a program storage region 231 and a data storage region 232. Various programs are stored in the program storage region 231. The various programs include firmware such as printing processing programs. The data storage region 232 stores various data and the like for executing the various programs.

The processor 210 is a device configured to execute data processing, and is, for example, a processor such as a CPU. The processor 210 executes various programs stored in the program storage region 231.

The display unit 240 is, for example, a liquid crystal display, and may display various kinds of information. The operation unit 250 is a device that receives an operation by the user. The user may operate the operation unit 250 to input various instructions to the printer 200. The communication interface 270 is a wired or wireless network interface for communicating with other devices, and is connected to the network NT.

The printing unit 290 prints an image on a sheet conveyed by a conveying mechanism (not illustrated). The printing unit 290 prints an image on the sheet based on print data transmitted from the terminal device 100 or a print job generated by the printing unit 290 based on an operation on the operation unit 250.

What is claimed is

1. A non-transitory computer readable storage medium storing an information processing program executable by a processor of an information processing device, the information processing program being configured to execute print control using a printing device by communicating with the printing device connected to the information processing device, the information processing device being loaded with an operating system having OS standard printing software,
wherein the information processing program is configured to, when executed by the processor, cause, on a condition that the printing device is not yet connected to the information processing device, a controller of the information processing device to execute:
a registration process of registering, as a virtual printer corresponding to the printing device, the information processing program in the OS standard printing software by responding to a search for a printer according to the OS standard printing software; and
a capability information output process of outputting capability information of the printing device in response to a request for the capability information from the OS standard printing software, and
the information processing program is configured to, when executed by the processor, cause, after the printing device is connected to the information processing device, the controller of the information processing device to execute:
a print data acquisition process of acquiring first print data from the OS standard printing software corresponding to the capability information outputted in the capability information output process; and
a print data transmission process of transmitting second print data based on the first print data to the connected printing device.

2. The non-transitory computer readable storage medium according to claim 1,
wherein the information processing program is further configured to, when executed by the processor, cause, on the condition that the printing device is not yet connected to the information processing device, the controller of the information processing device to further execute:
a capability information acquisition process of acquiring the capability information of the printing device, before the registration process; and
a capability information storage process of storing and holding the capability information acquired in the capability information acquisition process.

3. The non-transitory computer readable storage medium according to claim 2,
wherein in the capability information acquisition process, the capability information is acquired by receiving an input of the capability information via an operation unit provided in the information processing device.

4. The non-transitory computer readable storage medium according to claim 2,
wherein in the capability information acquisition process, the capability information is acquired by receiving the capability information transmitted from an external device.

5. The non-transitory computer readable storage medium according to claim 1,
wherein the information processing program is further configured to, when executed by the processor, cause, on the condition that the printing device is not yet connected to the information processing device, the controller of the information processing device to further execute:
an instruction receiving process of receiving a print execution instruction based on third print data from the OS standard printing software corresponding to the capability information output in the capability information output process,
wherein in the print data transmission process, fourth print data based on the third print data is transmitted to the connected printing device.

6. The non-transitory computer readable storage medium according to claim 1,
wherein the information processing program is configured to, when executed by the processor, cause, on the condition that the printing device is not yet connected to the information processing device, the controller of the information processing device to further execute:
a first notification signal output process of outputting a first notification signal for performing a corresponding first error notification, when receiving a print execution instruction based on third print data from the OS standard printing software corresponding to the capability information outputted in the capability information output process.

7. The non-transitory computer readable storage medium according to claim 1,
wherein the information processing program is configured to, when executed by the processor, cause, on the condition that the printing device is not yet connected to the information processing device, the controller of the information processing device to further execute:
a second notification signal output process of outputting a second notification signal for performing a corresponding second error notification.

8. The non-transitory computer readable storage medium according to claim 2,
wherein in the capability information acquisition process, access information and identification information of the printing device to be connected are acquired in addition to the capability information.

9. An information processing device comprising:
a communication I/F configured to communicate with a printing device; and
a controller including an operating system having OS standard printing software and an information processing program,
wherein the controller is configured to execute, on a condition that the printing device is not yet connected to the information processing device:
a registration process of registering, as a virtual printer corresponding to the printing device, the information processing program in the OS standard printing software by responding to a search for a printer according to the OS standard printing software; and
a capability information output process of outputting capability information of the printing device in response to a request for the capability information from the OS standard printing software; and
wherein the controller is configured to execute, after the printing device is connected to the information processing device:
a print data acquisition process of acquiring first print data from the OS standard printing software corresponding to the capability information outputted in the capability information output process; and
a print data transmission process of transmitting second print data based on the first print data to the connected printing device.
